(19) United States
(12) Patent Application Publication
(10) Pub. No.: US 2023/0064775 A1
(43) Pub. Date: Mar. 2, 2023

(54) INTERACTIVE PLANNING IN HIGH-DIMENSIONAL SPACE

(71) Applicant: MICROSOFT TECHNOLOGY LICENSING, LLC, Redmond, WA (US)

(72) Inventor: Robin ABRAHAM, Redmond, WA (US)

(21) Appl. No.: 17/459,654

(22) Filed: Aug. 27, 2021

(51) Int. Cl. G06N 20/00; G06F 9/455; G06F 16/901

(52) U.S. Cl. CPC G06N 20/00; G06F 9/455; G06F 16/9024

(57) ABSTRACT

Systems and methods are provided for generating and modifying a state-transition graph based on thresholds and constraints for simulated dependency graphs. For example, systems obtain a dependency graph that defines dependencies between data sources and transformation functions. A state-transition graph is generated based on simulating the dependency graph. A user is able to modify the state-transition graph in a simulation environment. Systems are also configured to generate outputs based on comparing a real-life execution of a plan and its corresponding state-transition graph.

### BACKGROUND

There are many real-world processes that benefit from preparing a well-thought-out plan. Plans can be as simple as a list of “to-do” items or as complicated as multi-step iterative systems requiring multiple resources. There are different management and planning software programs that help track and monitor different processes such as benchmarking goals for a team on a project or a manufacturing schedule. However, typically these planning systems require a user to manually construct the entire plan, including each step and transition between each step of the process.

Conventional processes for comparing the current statuses of an executed plan in real life versus a simulated plan are typically performed manually. This type of analysis also typically requires human intervention at every step of the plan execution to determine the state of various plan elements, how the plan is progressing, and what needs to be done next. In some industries, such as chemical and mechanical manufacturing processes, there are tools that make the process more efficient, such as some computer tools that can be used to ensure that there is adequate inventory and that correct resources are available for the different steps of the plan. However, even in such scenarios, a human user is still needed to generate and monitor the plan at each step. This is very time-consuming and expensive. This type of human involvement can also result in undesired human errors and slower recognition and response times to fixing issues when plans do not execute as originally anticipated.

Accordingly, there is an on-going need and desire for improved systems, methods, and devices for planning, and particularly, for improved systems, methods, and devices that can be utilized to improve planning systems that have complex process environments, so as to more efficiently and effectively perform interactive planning between computing systems and human users.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, methods, and devices that are configured to facilitate interactive planning in high dimensional spaces and, even more particularly, for facilitating human-in-the-loop interactive planning with the use of uniquely designed and implemented machine learning models.

Disclosed embodiments include machine learning models that are trained or trainable to generate a state-transition graph based on thresholds and constraints for simulated dependency graphs. For example, systems obtain a dependency graph configured as a first representation of the process. The dependency graph comprises data nodes and transformation nodes. Then, disclosed systems receive a user input defining one or more parameter constraints of the dependency graph and a state-transition graph for the process is generated by simulating an execution of the dependency graph based on the one or more parameter constraints.

The state-transition graph includes a second representation of a plurality of plan states based on the data nodes and the transformation nodes. The plan states include a first plan state corresponding to a start state associated with the process, a second plan state corresponding to a goal state associated with the process, the goal state being dependent on the start state, a transition representing a path for the process to progress from the start state to the goal state, and a tolerance threshold defining a pre-specified deviation range of one or more of the plan states.

Disclosed systems are also directed to systems and methods for generating and modifying the state-transition graph based on a graph simulation activity. For example, disclosed systems obtain a dependency graph configured as a first representation of the process. The systems also generate a state-transition graph for the process by simulating an execution of the dependency graph. The state-transition graph comprises a second representation of a plurality of plan states including a first plan state corresponding to a start state associated with the process, a second plan state corresponding to a goal state associated with the process, the goal state being dependent on the start state, a transition representing a path for the process to progress from the start state to the goal state, and a tolerance threshold defining a pre-specified deviation range of one or more of the plan states.

The systems simulate an execution of the state-transition graph, generate and present one or more outputs from simulating the execution of the state-transition graph at a user interface, and receive a user input through the user interface for modifying the state-transition graph, the user input defining a modification to the state-transition graph. In response to receiving the user input, the systems modify the state-transition graph based on the user input.

Systems and methods are also provided for generating and modifying a state-transition graph based on execution of the real-life process corresponding to the process represented by the state-transition graph. For example, systems obtain a dependency graph configured as a first representation of the process and generate a state-transition graph for the process by simulating an execution of the dependency graph. The systems also receive a user input associated with the one or more actual states resulting from the real-life execution of the process. The user input defines a modification to the state-transition graph, including a modification to the one or more plan states or tolerance threshold. In response to receiving the user input, the systems modify the state-transition graph by modifying the one or more plan states or tolerance threshold based on the user input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture that includes a computing system that includes and/or that is capable of being utilized to implement the disclosed embodiments.

FIG. 2 illustrates an example embodiment of a dependency graph.

FIG. 3 illustrates an example embodiment of a state-transition graph.

FIG. 4 illustrates an example embodiment of a state-transition graph including multiple dependent plans.

FIG. 5 illustrates an example embodiment of a process flow diagram for modifying a state-transition graph.

FIG. 6 illustrates an example embodiment of a process flow diagram for modifying a state-transition graph based on plan breakages through different versions.

FIG. 7 illustrates a process flow diagram comprising a plurality of acts associated with a method for generating a state-transition graph.

FIG. 8 illustrates a process flow diagram comprising a plurality of acts associated with a method for modifying a state-transition graph based on graph simulation.

FIG. 9 illustrates a process flow diagram comprising a plurality of acts associated with a method for modifying a state-transition graph based on real-life execution of the process represented by the state-transition graph.

### DETAILED DESCRIPTION

Embodiments disclosed herein relate to systems, methods, and devices that are configured to facilitate interactive planning in high dimension space, and even more particularly, for systems, methods, and devices that can be utilized to generate and modify state-transition graphs to facilitate human-in-the-loop interactive planning.

The disclosed embodiments provide many technical advantages over existing systems, methods, and devices. For example, systems and methods are provided that allow a domain expert to specify one or more assumptions in terms of parameters that can vary or be fixed throughout the process. The disclosed embodiments are also directed to a software architecture that beneficially incorporates many different types of data transformations including basic functions, constraint solvers, and/or artificial intelligence models for predicting and simulating various outcomes.

The disclosed systems allow a user to specify the dependencies between different data sources and planning functions as plan dependency graph (e.g., represented by a data flow graph). Data is allowed to propagate as fully solved or partially solved constraints through the dependency graph. The systems are also configured to execute the plan dependency graph in order to simulate a plan and generate a plan state-transition graph under user-specified settings and constraints.

Because the systems capture the underlying state snapshots at each step of prediction and simulation, a user can traverse various parts of the state-transition graph. The systems are beneficially configured to allow a user to tweak any node included in the state-transition graph wherein the user can explore alternate paths. This generates alternate plans, whereby the systems are able to run predictions and simulations for the alternate plans and compare them against the original plans.

Disclosed embodiments are also directed to generating multiple-dependency plans where a user is able to leverage outcomes or states from one plan within another plan that might be executing in sequency or simultaneously with the first plan. The systems allow users to reflect deviations from predicted outcomes during actual plan execution and to adjust the plan to account for different deviations. Multiple users are allowed to jointly create and refine plans. Furthermore, the systems allow users to set alerts to trigger notifications or alternate workflows when states fall outside user-specified tolerance limits. In addition, the systems are configured such that users can leverage plans created by other domain experts as templates to use as starting points for their own planning activities. Because of these technical benefits, and many others as will be discussed herein, the disclosed embodiments beneficially provide improved systems and methods for facilitating interactive planning with the use of machine learned or machine learning modules.

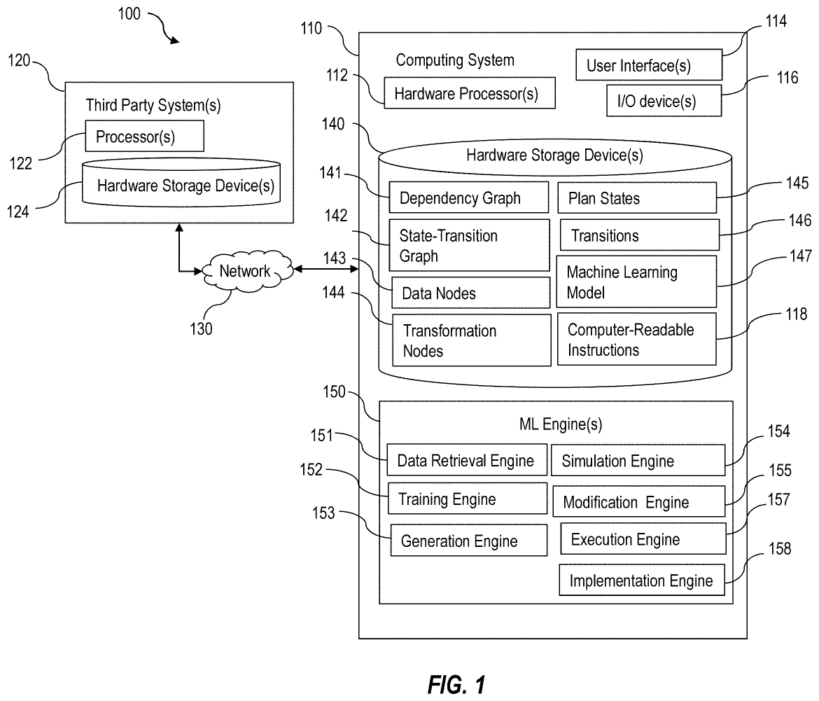

Attention will now be first directed to FIG. 1, which illustrates a computing system 110 that may include or be used to implement aspects of the claimed invention. In particular, the computing system 110 is configured, as described throughout this disclosure, to generate, train, and operate a multi-modal analysis model configured to generate and modify plans, including dependency graphs and state-transition graphs which are various representations of plans and/or processes.

The computing system 110 is currently illustrated as part of a computing environment 100 that also includes third-party system(s) 120 (which can also be configured as remote systems) in communication (via a network 130) with computing system 110. These remote systems may include distributed portions of the computing system 110.

The computing system 110 is also illustrated as including one or more processor(s) (such as one or more hardware processor(s)) 112 and a storage (i.e., hardware storage device(s) 140) storing computer-readable instructions 118 wherein one or more of the hardware storage device(s) 140 is able to house any number of data types and any number of computer-readable instructions 118 by which the computing system 110 is configured to implement one or more aspects of the disclosed embodiments when the computer-readable instructions 118 are executed by the one or more processor(s) 112. The computing system 110 is also shown including user interface(s) 114 and input/output (I/O) device(s) 116.

Hardware storage device(s) 140 is currently shown as a single storage unit. However, it will be appreciated that the hardware storage device(s) 140 is/are also sometimes implemented as a distributed storage which is distributed throughout several separate and sometimes remote systems and/or third-party system(s) 120. In this regard, it will be appreciated that the computing system 110 can comprise a distributed system with one or more of the components of computing system 110 being maintained/run by different discrete systems that are remote from each other and that each perform different tasks. In some instances, for example, the computing system 110 operates as a plurality of distributed systems that perform similar and/or shared tasks for implementing the disclosed functionality, such as in a distributed cloud environment. It should be appreciated that the systems and methods are adaptable to any number of domains.

The hardware storage device(s) 140 are configured to store the different data types including dependency graphs 141, state-transition graphs 142, data nodes 143, transformation nodes 144, plan states 145, and transitions 146, described herein. A dependency graph is a data flow graph that represents dependencies between various data sources (e.g., data nodes 143) and planning functions (e.g., transformation nodes 144). A dependency graph is configured as a representation of a particular process and are also defined by one or more parameter constraints by a user. The transformation nodes are configurable as data functions that perform a transformation on input data, as constraint solvers that at least partially solve a constraint to generate a solution as an output, as a probabilistic model, and/or as an AI model. Where the transformation node is an AI model, the model is trained to perform a classification task and/or a regression task.

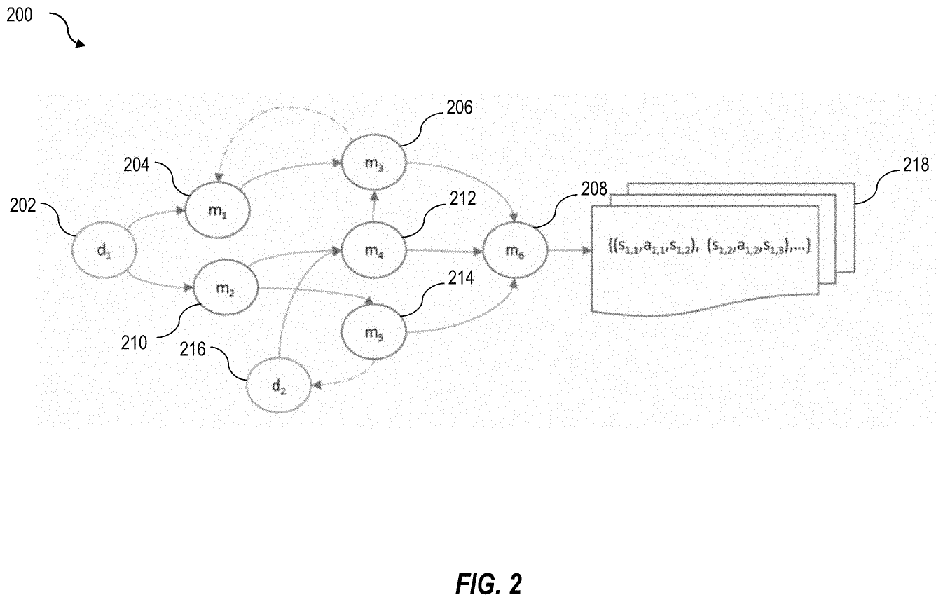

In some instances, the dependency graphs 141 include at least one back edge configured as an implicit back edge or an explicit back edge. In some instances, the dependency graph is segmented into a plurality of sub-graphs, wherein each sub-graph is independently executable based on a pre-determined number of iterations or based on a condition being met. The dependency graphs 141 are further described in reference to FIG. 2.

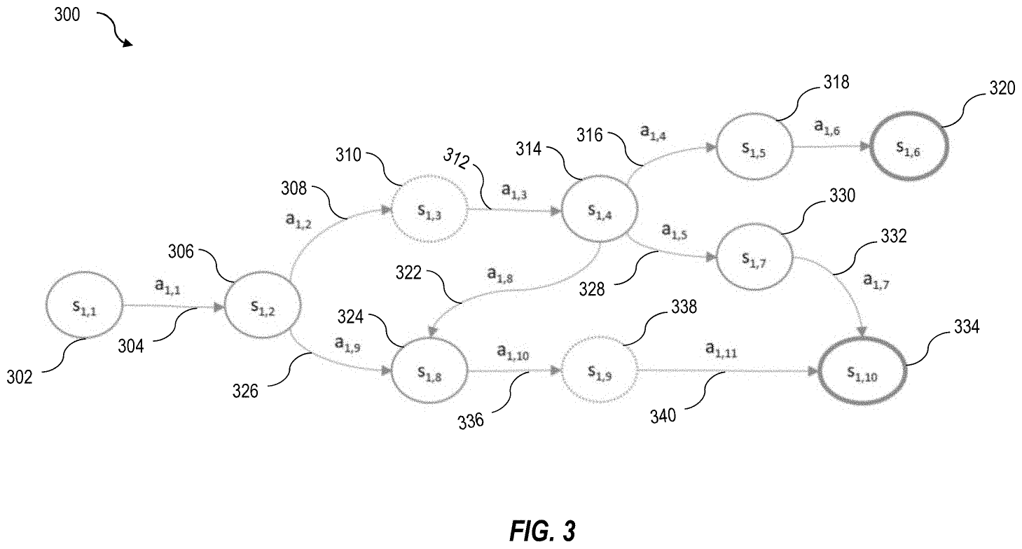

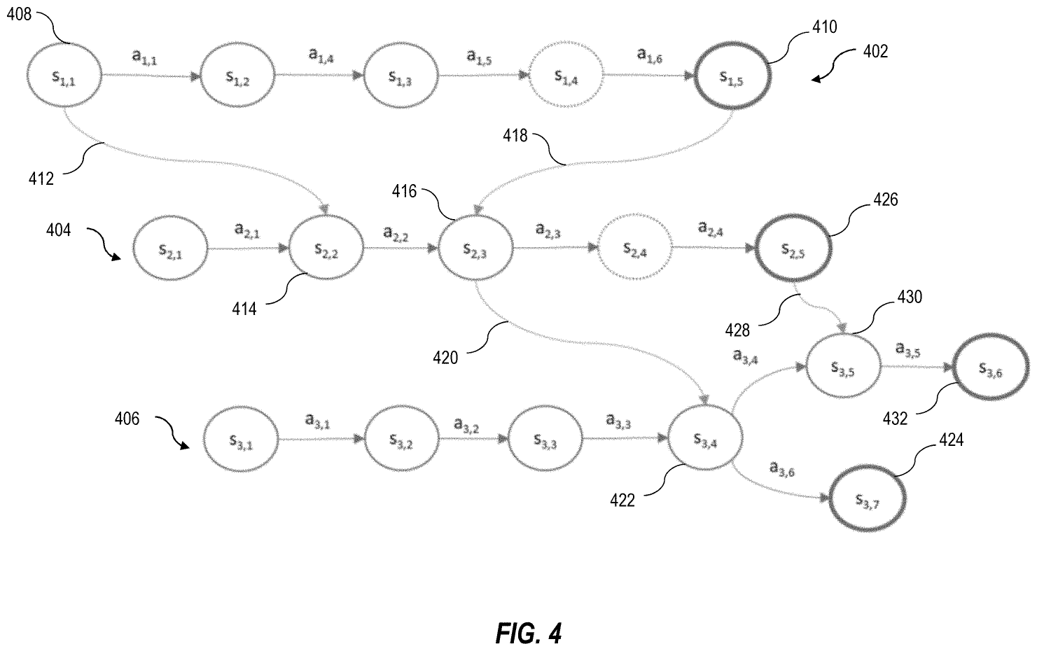

State-transition graphs 142 are generated from simulating an execution of the dependency graphs 141 based on the parameter constraints and include plan states 145 and well as transitions 146 between the plan states 145. For example, a state-transition graph includes at least a start state, a goal state, a transition representing a path for the process to progress from the start state to the goal state, and a tolerance threshold defining a deviation range for one or more of the plan states included in the state-transition graph. Transitions are created based on the result of an action (e.g., previous plan state), a result of an intervention triggered by the computing system (e.g., an alternate workflow path or user modification), and/or as a result of a condition being met or a condition being violated. State-transition graphs 142 also include implicit intermediate states between different plan states. State-transition graphs 142 are further described in reference to FIGS. 3-4.

The storage (e.g., hardware storage device(s) 140) also stores or includes computer-readable instructions 118 that are executable by the systems hardware processors for instantiating or implementing the disclosed models and/or engines shown in computing system 110 (e.g., the machine learning model 147). The computing system 110 is configured to build and operate a machine learning model 147 that is trainable to generate dependency graphs 141, state-transition graphs 142, modify components of the different graphs and plans, simulate the process represented by the state-transition graph, and/or monitor a real-life execution of the process.

The referenced models are configured as machine learning models or machine learned models, such as deep learning models and/or algorithms and/or neural networks. In some instances, the one or more models are configured as engines or processing systems (e.g., computing systems integrated within computing system 110), wherein each engine (i.e., model) comprises its own discrete set of one or more processors (e.g., hardware processor(s) 112) and computer-readable instructions 118.

An additional storage unit for storing machine learning (ML) Engine(s) 150 is presently shown in FIG. 1 as storing a plurality of machine learning models and/or engines. For example, computing system 110 comprises one or more of the following: a data retrieval engine 151, a training engine 152, a generation engine 153, a simulation engine 154, a modification engine 155, an execution engine 157, and an implementation engine 158, which are individually and/or collectively configured to implement the different functionality described herein.

For example, the data retrieval engine 151 is configured to locate and access data sources, databases, and/or storage devices comprising one or more data types from which the data retrieval engine 151 can extract sets or subsets of data to be used as training data or for sources for the different plan states. The data retrieval engine 151 receives data from the databases and/or hardware storage devices, wherein the data retrieval engine 151 is configured to reformat or otherwise augment the received data to be used as data for the plan(s). Additionally, or alternatively, the data retrieval engine 151 is in communication with one or more remote systems (e.g., third-party system(s) 120) comprising third-party datasets and/or data sources. In some instances, the data sources are also configured as raw material sources (or data about the raw material sources), for example, in different manufacturing processes.

The data retrieval engine 151 (also configured as a source material engine) accesses electronic content and/or outcomes from other plans. The data retrieval engine 151 is configured to retrieve and generate training datasets for the different AI models described herein. The data retrieval engine 151 is a smart engine that is able to learn optimal dataset extraction processes to provide a sufficient amount of data in a timely manner as well as retrieve data that is most applicable to the desired applications for which the machine learning models/engines will be used. For example, the data retrieval engine 151 can learn which databases and/or datasets will generate training data that will train a model (e.g., for a specific query or specific task) to increase accuracy, efficiency, and efficacy of that model in the desired planning techniques.

The data retrieval engine 151 locates, selects, and/or stores raw recorded source data such that the data retrieval engine 151 is in communication with one or more other ML engine(s) and/or models included in computing system 110. In such instances, the other engines in communication with the data retrieval engine 151 are able to receive data that has been retrieved (i.e., extracted, pulled, etc.) from one or more data sources such that the received data is further augmented and/or applied to downstream processes. For example, the data retrieval engine 151 is in communication with the training engine 152 and/or implementation engine 158.

The training engine 152 is in communication with one or more of the data retrieval engine 151 and/or the implementation engine 158. In such embodiments, the training engine 152 is configured to receive one or more sets of training data from the data retrieval engine 151. After receiving training data relevant to a particular application or task, the training engine 152 trains one or more models on the training data. The training engine 152 is configured to train a model via unsupervised training, such as self-supervision, or distant supervision, and/or supervised training (i.e., direct supervision).

The generation engine 153 is configured to dynamically generate the dependency graphs 141 and the state-transition graphs 142 based on various user settings. The generation engine is configured to obtain a dependency graph configured as a first representation of the process and generate a state-transition graph for the process by simulating an execution of the dependency graph.

The simulation engine 154 is configured to simulate the dependency graph (in order to generate the state-transition graph) and to simulate the state-transition graph (in order for a user to explore and/or modify the state-transition graph). The simulation engine 154 is also in communication with the execution engine 157 such that a user is able to compare actual states of the plan as seen via the execution engine with the predicted states of the plan as simulated by the simulation engine 154. The simulation engine 154 is also in communication with a modification engine 155.

The modification engine 155 is configured to modify the different nodes of the plans, including modifying dependencies between data nodes and transformation nodes in the dependency graphs and modifying plan states and/or transitions between plan states of the state-transition graphs. The modification engine 155 is also configured to receive user input to facilitate the various modifications, as well as to modify existing parameters and constraints previously defined by a user.

The modification engine 155 is also configured to automatically modify different nodes/plan states/plans based on information learned by the machine learning model 147 or automatically based on pre-defined alternate workflow pathways. The modification engine 155 is configured to facilitate an environment in which a user is able to explore and simulate various plans, including creating new plans and adapting existing plans.

After the state-transition graph is simulated, the modification engine 155 is configured to generate and present one or more outputs from simulating the execution of the state-transition graph at a user interface. The modification engine 155 is also configured to receive a user input through the user interface for modifying the state-transition graph. The user input defines a modification to the state-transition graph. In response to receiving the user input, the modification engine is configured to modify the state-transition graph based on the user input.

In some instances, the referenced modifications include traversing an intermediate state, defining an alternate workflow path, changing a constraint, or setting a trigger based on a pre-determined condition being met.

The modification engine 155 is also configured to monitor the various deviation thresholds defined for each plan state and/or transition such that modifications can be made automatically or an alert for a user to modify the plan can be generated when deviation ranges are exceeded.

The execution engine 157 is configured to execute a real-life execution of the process represented by the state-transition graph. In a manufacturing domain for creating a chemical compound, the execution engine 157 would then facilitate the operation of various machinery and materials based on a plan for the engineering process. A process is ready to be executed in real life when the different real-life input sources for the dependency graph are accessible and in communication with the computing system, such that the process is deemed to be “online”.

The computing system 110 also includes an implementation engine 158 in communication with any one of the models and/or ML engine(s) 150 (or all of the models/engines) included in the computing system 110 such that the implementation engine 158 is configured to implement, initiate, or run one or more functions of the plurality of ML engine(s) 150. In one example, the implementation engine 158 is configured to operate the data retrieval engines 151 so that the data retrieval engine 151 retrieves data at the appropriate time to be able to generate training data for the training engine 152. The implementation engine 158 facilitates the process communication and timing of communication between one or more of the ML engine(s) 150 and is configured to implement and operate a machine learning model (or one or more of the ML engine(s) 150).

The computing system is in communication with third-party system(s) 120 comprising one or more processor(s) 122, one or more of the computer-readable instructions 118, and one or more hardware storage device(s) 124. It is anticipated that, in some instances, the third-party system(s) 120 further comprise databases housing data that could be used as training data, for example, audio data not included in local storage. Additionally, or alternatively, the third-party system(s) 120 include machine learning systems external to the computing system 110. The third-party system(s) 120 are software programs or application.

Attention will now be directed to FIG. 2, which illustrates an example embodiment of a dependency graph. FIG. 2 shows a dependency graph 200 which defines the dependencies between a plurality of data nodes and a plurality of transformation nodes. For example, transformation node 204 and transformation node 210 are dependent on data node 202. Transformation node 206 is dependent on transformation node 204 and transformation node 212. Transformation node 212 is dependent on transformation node 210. Transformation node 214 is also dependent on transformation node 210 and data node 216. Thus, transformation node 208 is dependent on transformation node 206, transformation node 212, and transformation node 214, which results in a process 218 represented by the dependency graph 200. The plan dependency graph for a particular planning activity is created interactively by a domain expert (i.e., user) and captures the critical building blocks that allow a planning system to generate the various states and transitions that constitute a plan (i.e., process). A pure rule-based approach would not scale since there would be too many constraints and conditions to enumerate.

Plans can be dependent on data (e.g., data nodes). These data nodes can represent data retrieved from output sources or be data that represents information about raw materials used in manufacturing processes. The dependency graph also includes transformation nodes of various types. For example, the transformations nodes are simple functions that manipulate data in various ways like sort, filter, join, concatenate, and project/select. Transformation nodes also solve constraints and produce solutions as outputs. Such constraint solvers can propagate solutions or even unsolved (or partially solved) constraints downstream in the graph to other nodes.

Some transformation nodes are probabilistic models that can carry out Monte Carlo simulations and generate sequences of outputs or even short-horizon plans. Depending on the applications, these models and simulations can leverage concepts and knowledge from underlying domains like physics, biology, mathematics, finance, chemistry, etc. In some instances, the dependency graph could represent a bioreactor, wherein the different data nodes represent data about temperature, volume, viscosity, ratios of elements, and detection levels of desired bacteria included in the bioreactor or being received by the bioreactor. The transformation nodes represent the different processes that each of the data/sources undergo. For example, raw materials are input to the reactor, wherein a heater is used to raise the internal temperature of the reactor such that the materials increase in temperature. A transformation node may also represent a valve which controls the volume of raw material entering the bioreactor.

The referenced AI models can incorporate high number of dimensions. For instance, the disclosed models might perform a classification or regression/prediction task. The referenced AI models can also be used to simulate the response from the environment. Given the free variables among the operational parameters, the models can determine or operate based on which terms are held constant and which variables the user is allowed to modify. With techniques like model-based deep reinforcement learning, nodes can also generate plans within the specified context.

Transformation nodes can take inputs directly from data sources (transformation node 204 and transformation node 210 transform data from data node 202), one or more nodes upstream (transformation node 206 consumes output from transformation node 204 and transformation node 212), or from a combination of data and transformation nodes (transformation node 212 consumes data from data node 216 and output from transformation node 210).

A domain expert working on a plan can interact with the dependency graph (through the system) and influence the output. For the sake of simplicity, these input mechanisms have not been explicitly shown in FIG. 2. In general, each of the transformation node 204 through transformation node 208 have user-specified inputs and settings (defaults could be learned).

FIG. 2 also illustrates the dependency graph 200 having a back edge between transformation node 206 and transformation node 204, as well as a back edge between transformation node 214 and data node 216. General data-flow programming languages and representations require the program graphs to be directed and acyclic (i.e., without any back edges that might result in cycles in the graph). This requirement is enforced to avoid infinite loops in the program.

The system allows for back edges and cycles of different types in planning dependency graphs. One type are implicit back edges that can update or augment data sources. For example, transformation node 214 has a back edge that updates data node 216. The updates would influence inputs to transformation node 214 and subsequent computations. An explicit back edge can direct outputs from one transformation node back to another node, upstream in the data flow. For example, transformation node 214 performs transformations based on input from transformation node 204, and also influences the computation performed by the transformation node 204 through the back edge.

Overall, the entire graph can be executed for one or more iterations. The user can tweak the inputs to the transformation nodes to generate the start state, transition and end state tuples for multiple state transitions that describe the high-level plan. How these states and transitions can be explored and leveraged by the human expert as a plan is described in reference to the following figures.

In some embodiments, the system includes a user interface that is configured to allow a user to interact with various components of the system to bring about different results, outputs, and products. For example, the user interface is configured to receive user input and to display various outputs. In some instances, the user interface receives user input related to different data nodes and/or transformation nodes. For example, a user is able to create new nodes for new data nodes and/or transformation nodes, or select a node from a database of pre-defined nodes. Once two or more nodes are selected, a user is able to select a type of dependency between the nodes.

The user interface is also configured to present one or more outputs related to the dependency graph. In some instances, the user interface displays a graphical representation of the dependency graph. In some instances, the user interface displays a numerical representation of the dependency graph. Additionally, or alternatively, the user interface is configured to display the code script from which the dependency graph is executed. In similar manner, the user is able to modify the dependency graph at a graphical level, at a numerical level, or at a code level. The user interface is also configured to receive user input related to the constraints and/or parameters of the dependency graph. In some instances, one or more constraints are global restraints that affect the dependency graph as a whole. Alternatively, one or more constraints only affect one or more particular nodes or dependencies.

Attention will now be directed to FIG. 3, which illustrates an example embodiment of a state-transition graph 300, for example, as generated by simulating an execution of the dependency graph 200 illustrated in FIG. 2. As shown in FIG. 3, the state-transition graph 300 includes a plurality of plan states (start state 302, plan state 306, plan state 310, plan state 314, plan state 318, plan state 324, plan state 338, plan state 330) and a plurality of transitions (e.g., transition 304, transition 308, transition 312, transition 316, transition 328, transition 332, transition 326, transition 322, transition 336, and transition 340) to achieve a plurality of goal states (e.g., goal state 320 and goal state 334). The various plan states are dependent on one or more plan states. The process progresses between different plan states, and between the plan states and the goal states via the different transitions. The goal states are the final goals that the plan should progress to and achieve.

A state-transition graph for a plan captures the likely paths from a start state to one or more goal states, taking into consideration intermediate states and transitions along those paths. The more states and transitions that are considered and incorporated, the more detailed the resulting plan would be. However, the level of detail incorporated in a plan is not necessarily a predictor of its accuracy or likelihood of success.

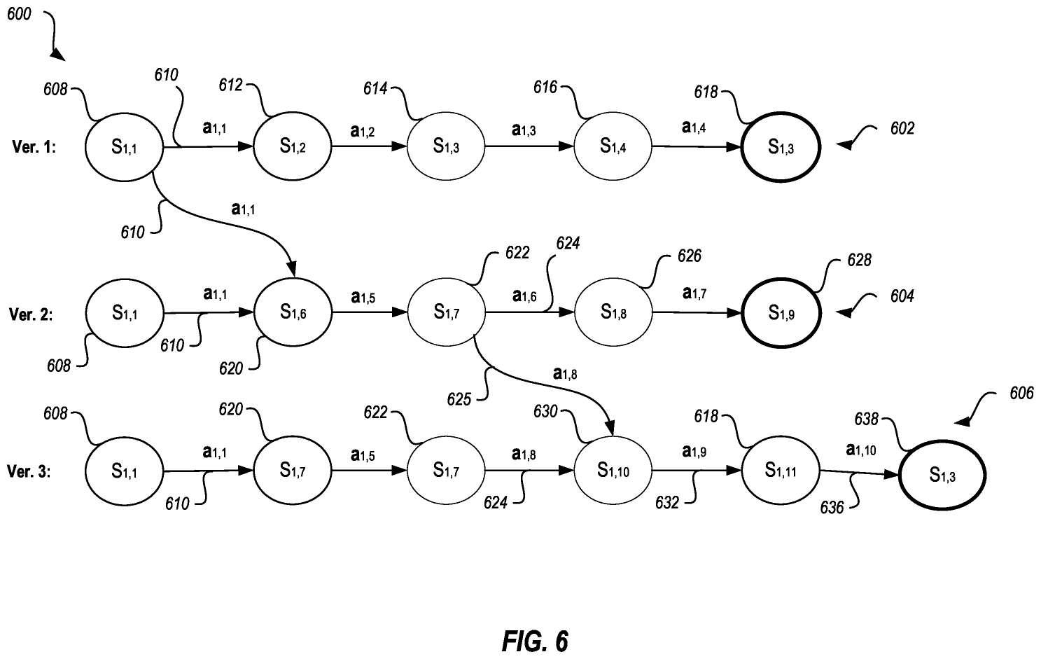

A plan, as defined herein, does not need to specify, or define actions for every possible state. A user may create a plan that only has to capture the critical states and transitions and provide thresholds or acceptable tolerance levels for the parameters. If the relationships between states through the corresponding transitions or the thresholds are violated during plan execution, that would count as a plan breakage, and require plan repair, as described in reference to FIG. 6.

State transitions can also involve multiple steps in sequence (transition 336 and transition 340), where the implicit intermediate state (e.g., plan state 338) is not directly generated from the plan dependency graph, even though it might still be viewed/inspected by the planner. Such intermediate states are called hidden states. Different transitions from a state could take the system to different states. For example, starting at plan state 314, transition 316, transition 328, and transition 322 take the system to plan state 318, plan state 330, and plan state 324, respectively. A state could be the outcome of transitions from one or more states. For example, both the transition 322 from plan state 314 and the transition 326 from plan state 306 result in plan state 324.

Attention will now be directed to FIG. 4, which illustrates an example embodiment of a state-transition graph including multiple dependent plans. For example, FIG. 4 illustrates a plurality of plans (e.g., plan 402, plan 404, and plan 406). Each plan includes a plurality of plan states and a plurality of transitions, which are dependent on plan states and transitions of the same plan and of a different plan. For example, plan state 414 of plan 404 is dependent on plan state 408 via dependency transition 412. Plan 404 is further dependent on plan 402 because plan state 416 is dependent on goal state 410 via dependency transition 418. A dependency transition is. transition that defines the relationship and/or progress between plan states of different plans (i.e., as represented by their respective state-transition graphs).

Furthermore, plan 406 is dependent on plan 404. For example, plan state 422 is dependent on plan state 416 based on dependency transition 420. Additionally, plan state 430 is dependent on goal state 426 via dependency transition 428. Thus, in order for each of the goal states (e.g., goal state 410, goal state 426, goal state 424, and goal state 432) to be achieved, each of the plan states that are part of dependency relationships must be working and must not deviate past a deviation threshold defined for each plan state or dependency transition.

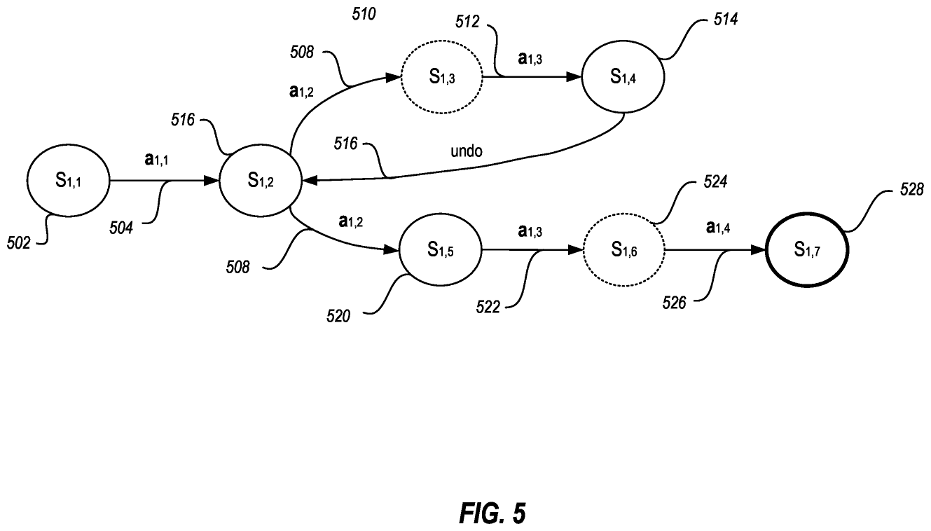

Attention will now be directed to FIG. 5, which illustrates an example embodiment of a process flow diagram for modifying a state-transition graph. FIG. 4 illustrates a state-transition graph which originally included a start state 502, a plan state 506 based on transition 504, plan state 510 based on transition 508, and plan state 514 based on transition 512. FIG. 4 also illustrates a modification 516 to the state-transition graph such that transition 508 actually leads to plan state 520. From plan state 520, transition 522 leads to plan state 524, and transition 526 leads to goal state 528.

The modification of the state-transition graph can be made in response to a user exploring various possible outcomes of a plan or based on the transition 508, leading to the previously unpredicted plan state (e.g., plan state 520) in a simulation or in a real-life execution. In some instances, the modification is made during an interactive and iterative state-exploration activity.

For example, an intermediate step in the creation of a simple plan is shown. The original exploration traversed hidden state s_{1,3} (e.g., plan state 510) to get to the plan state 514. After the planner tweaked the input parameters and assumptions, it was observed that transition 508 would lead to plan state 520 followed by a composite action that results in the outcome of goal state 528, which is the desired goal state.

The disclosed embodiments allow for users to traverse such state transitions, implicitly or explicitly, and tweak the assumptions (to determine which parameters are relevant), explore the likely transitions (to specific which models and simulations should run), and set triggers and notifications.

It should be appreciated that the state-transition graph can be represented to a user through a user interface that configured to display an original state-transition graph as the result of executing the dependency graph, display a modified or modifiable state-transition graph, and/or display outputs corresponding to the state-transition graph. The state-transition graph is displayed in different formats. In one example, the state-transition graph is displayed in a graphical representation (e.g., like those depicted in FIGS. 2-6).

In another example, the state-transition graph is displayed based on numerical outputs and/or parameters related to the different states and transitions. In some instances, the state-transition graph is displayed via the code script corresponding to the state-transition graph. In some embodiments, only one node is displayed, while in other embodiments, the entire state-transition graph is displayed, or only sub-graphs of the state-transition graph are displayed.

The user interface is also configured to receive user input to modify the state-transition graph. In some instances, where the state-transition graph is displayed graphically, a user is able to graphically modify the state-transition graph by manually moving, changing, deleting, or adding various plan states and/or transitions. In some instances, a user is able to numerically modify the state-transition graph by replacing values for different constraints and parameters related to the state-transition graph. Additionally, or alternatively, a user is able to access the code script from which the state-transition graph is executed and modify or delete existing code or add new code in the corresponding programming language. It should be appreciated that any programming language is usable, including HTML, Python, R, C++, and other languages to provide and/or examine the corresponding constraints, parameters and states of the state-transition graph.

In some embodiments, a user is able to query against a particular node (e.g., plan state) or edge (e.g., transition) to obtain a predicted output if it is a simulation or the actual output if it is a representation of real-life execution of the state-transition graph. The modifications can also be made via a drop-down menu that presents a listing of the different plan states and transitions, wherein a user is able to select the desired component of the state-transition graph to modify using one or more modification methods described herein.

The user interface is also configured to receive user input modifying one or more deviation thresholds. In some embodiments, modifications are made to the state-transition graph automatically based on a predicted or actual output exceeding a predetermined deviation threshold. In such embodiments, the user interface is configured to display the automatic modifications and generate and display notifications about which modifications were made and why the modifications were made (e.g., identifying which deviation threshold was exceeded and by how much).

In some embodiments, once a plan has been created, reviewed, and signed off, it is ready to be executed in real-life. A plan is online if the outcomes and data from the systems that participate in the plan (the environment), can be directly provided to the system through direct connections or API calls. These data do not all have to be in structured format and can involve unstructured, high-dimensional data that require AI models to ingest or interpret them. A plan is fully offline if the data cannot be provided to the system. In such instances, the outcomes and observations from the environment have to be manually interpreted by a human and updated in the system. Typically, most plans are expected to be executed as a hybrid between online and offline modes.

During execution, the planner can revisit and refine the plan by incorporating any observed deviations due to a variety of reasons. For example, errors in model-predicted outcome might deviate from what is observed in the real world. There might be changes in underlying assumptions that were made during planning. Observations might indicate that an assumption about an attribute being constant is invalid and the change has to be incorporated, either a new constant value, or as a variable that is incorporated into the planning and model inputs. Modifications can also be made based on feedback during plan execution that has to be now reflected in constraints and parameters.

Plan deviations are acceptable within pre-specified ranges of tolerance. In some cases, unexpected outcomes might also be flagged as “ok” by the user to indicate to the system that no exception needs to be triggered. This type of feedback can be incorporated into fine tuning the AI models involved in simulating the planning states.

In order to keep planning activities tractable and modular, plans can reference the outcomes from states within other plans (as shown in FIG. 5). The plans can evolve in different ways. In one example, plans can evolve side-by-side, in parallel, where outcomes from one or more plans are simultaneously fed into the current state of a given plan to compute its next state. In another example, plans can execute in series, one after another, where the final outcome from one is fed into the initial state of another. Additionally, or alternatively, a hybrid of the two options described above, where some instances run in parallel and others in sequence.

Attention will now be directed to FIG. 6, which illustrates an example embodiment of a process flow diagram for modifying a state-transition graph based on plan breakages through different versions. FIG. 6 illustrates a state-transition graph 600 under various versions including version 602, version 604, and version 606. The state-transition graph includes a plurality of plan states and a plurality of transitions. Originally, in version 602, the state-transition graph included start state 608 and transition 610 which lead to plan state 612. From there, the state-transition graph also included plan state 614, plan state 616, and goal state 618.

After modification which included transitioning from start state 608 to a new plan state 620 via transition 610, version 604 now reflects the new version. For example, version 604 includes start state 608 and the new plan state 620. From new plan state 620, the state-transition graph progresses to plan state 622 and onwards to plan state 626 (via transition 624) and finally to new goal state 628.

However, after further modification, version 606 is generated. For example, version 606 now includes start state 608 which progresses to new plan state 620 via transition 610. Version 606 also includes a plurality of plan states including plan state 622, plan state 630, plan state 634, and goal state 638, and a plurality of transitions including transition 624, transition 632, and transition 636. In some circumstances, a user may have goal state 638 as the final desired goal state. Thus, starting with version 602, the user is able to modify the state-transition graph until the final desired goal state is achieved (or simulated to be achieved). The computing system 110 is configured to store the various versions of the state-transition graph, based on linking the modified state-transition graphs to previous versions and/or the original state-transition graph.

Plan breaks and replanning are critical to adapting to changes and errors in assumptions. Therefore, the ability to capture state and assumptions, and revisit and iterate from any underlying state is critical. The system and user should consider different factors in order to determine a level of confidence associated with the plan. For example, the relevant parameters should be defined and then determined whether the plan addresses each of the relevant parameters correctly. Simple plans can be created by considering only a subset of operative parameters, but their accuracy might be low.

Important states should be captured and mapped out, wherein a user defines the important states, and the system can then determine whether a final version of a plan (or state-transition graph) accurately represents the important states. A plan that incorporates more states is at a finer granularity and can draw attention to plan breakage sooner.

In order to determine a confidence level associated with the plan, an accuracy score can be determined for the individual transformation nodes, including determining how accurate are the models or simulations that compute the transitions from one state to the next. If transitions are not reflected with reasonable levels of accuracy, it is quite likely that high-probability states will be missed.

Plan breakage occurs when there is a deviation between a plan state and actual state, or a transition was not accounted for. The breakage results in a state the original plan did not account for or provide fallbacks to recover from. In such a situation, it is important for the system to support plan repair and continued execution on the updated plan.

Referring back to FIG. 6, version 602 of the plan captures start state 608 through goal state 618 and the transitions between them. During execution, it was discovered that transition 610 from the start state 608 does not actually lead to plan state 612, but instead, it results in new plan state 620. The plan is repaired interactively, and the plan now reflects the fact that the result of transition 610 is new plan state 620, and subsequent states and transitions have also been updated, including the new goal state 628.

During execution of version 604 of the plan, it was discovered that transition 624 was not actually available from 622. The plan is updated to reflect selection of the optimal transition 625 resulting in plan state 630, together with the subsequent transitions and states to the new goal state (e.g., goal state 638). In the ideal case for the example shown in FIG. 6, the value (V) of the goal states satisfies the following relationship: V(s_{1,5})≤V(s_{1,9})≤V(s_{1,12}). That is, each version of the plan is at least as good as the previous one as more observations are generated from the environment. This condition is not usually satisfied, especially when plan breakage happens closer to the goal states, and the system has fewer options for optimizations.

It is also possible that the user carries out plan repairs to maintain the original goal state (e.g., goal state 618). In this case, the repairs are just alternate state traversals leading to goal state 618, and there are no other goal states (ideally, of potential higher value) the user is trying to reach. Thus, elasticity of plans is critical. If planning is just a rigid, top-down, static activity, the plans produced will be brittle. On the other hand, the disclosed embodiments provided herein allow users involved in planning to leverage their domain expertise and carry out planning as an interactive and exploratory exercise that leverages AI models and simulations to traverse the multi-dimensional state space. Moreover, plan breakages or deviations can be observed, and repairs can be performed bottom-up, thereby making plans elastic and resilient to flaws.

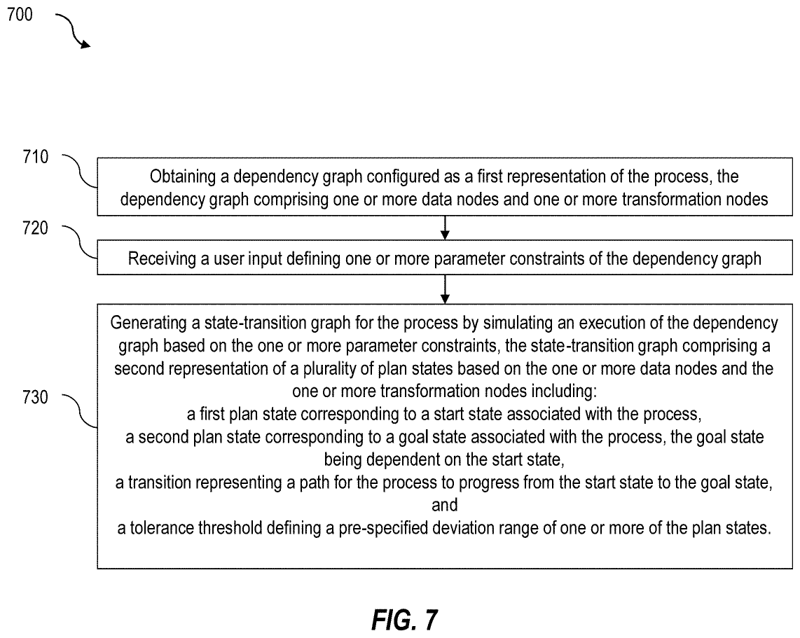

Attention will now be directed to FIGS. 7-9, which illustrates various example embodiments of methods for performing the disclosed embodiments. Although the method acts may be discussed in a certain order or illustrated in a flow chart as occurring in a particular order, no ordering is required unless specifically stated, or required because an act is dependent on another act being completed prior to the act being performed.

Attention will now be directed to FIG. 7, in some reference to FIG. 1, which illustrates a flow diagram 700 that includes various acts (act 710, act 720, and act 730) associated with exemplary methods that can be implemented by computing system 110 obtains a dependency graph configured as a first representation of the process (act 710). The dependency graph comprises one or more data nodes and one or more transformation nodes. The system also receives a user input defining one or more parameter constraints of the dependency graph (act 720) and then generates a state-transition graph for the process by simulating an execution of the dependency graph based on the one or more parameter constraints (act 730). The state-transition graph comprises a second representation of a plurality of plan states based on the one or more data nodes and the one or more transformation nodes.

For example, the state-transition graph includes a first plan state corresponding to a start state associated with the process, a second plan state corresponding to a goal state associated with the process, the goal state being dependent on the start state, a transition representing a path for the process to progress from the start state to the goal state, and a tolerance threshold defining a pre-specified deviation range of one or more of the plurality of plan states. In some embodiments, the state-transition graph further includes an implicit intermediate state.

In some instances, at least one transformation node is configured as a data function that performs a transformation on input data, as a constraint solver that at least partially solves a constraint to generate a solution as an output, as a probabilistic model, and/or as an artificial intelligence model. Where the transformation node is an artificial intelligence model, the model is trained to perform a classification task and/or a regression task.

In some instances, the dependency graph from which the state-transition graph is generated includes at least one back edge configured as an implicit back edge or an explicit back edge.

In some instances, the dependency graph is segmented into a plurality of subgraphs. In such instances, the method further comprises executing a particular subgraph for a fixed number of iterations or until a pre-determined condition is met.

The different transitions included in the state-transition graph are generated/simulated based on various implementations. For example, the transitions are based on a result of an action, a result of an intervention triggered by the computing system, and/or a result of a condition being met, or a condition being violated.

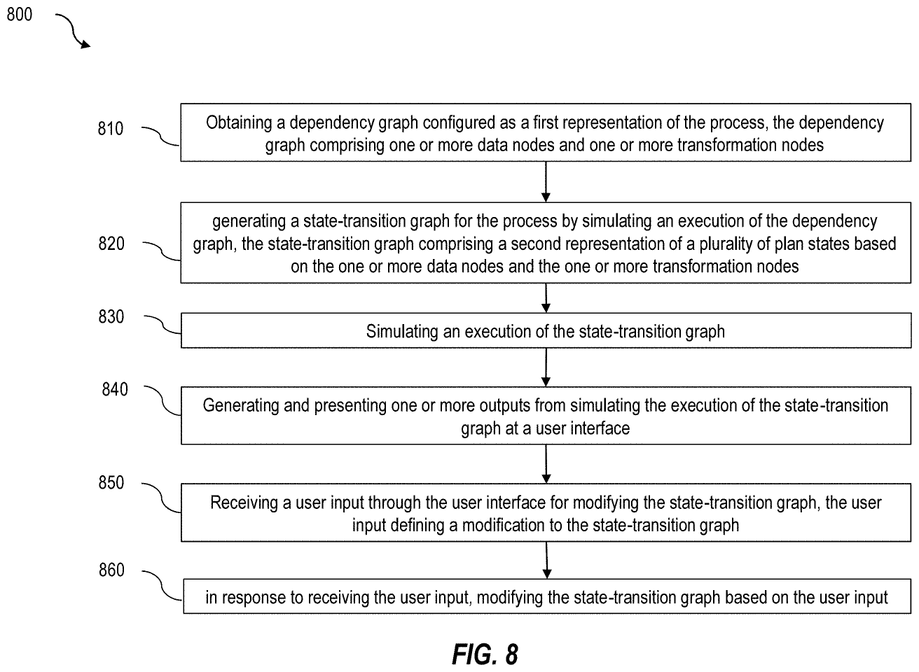

Attention will now be directed to FIG. 8, in some reference to FIG. 1, which illustrates a flow diagram 800 that includes various acts (act 810, act 820, act 830, act 840, act 850, and act 860) associated with exemplary methods that can be implemented by computing system 110 for modifying a state-transition graph based on a simulation of the process predicted by the state-transition graph. As illustrated, the system obtains a dependency graph configured as a first representation of the process (act 810). The dependency graph comprising one or more data nodes and one or more transformation nodes.

The system then generates a state-transition graph for the process by simulating an execution of the dependency graph (act 820). The state-transition graph comprising a second representation of a plurality of plan states based on the one or more data nodes and the one or more transformation nodes including: a first plan state corresponding to a start state associated with the process, a second plan state corresponding to a goal state associated with the process, the goal state being dependent on the start state, a transition representing a path for the process to progress from the start state to the goal state, and a tolerance threshold defining a pre-specified deviation range of one or more of the plurality of plan states.

The system simulates an execution of the state-transition graph (act 830) and generates and presents one or more outputs from simulating the execution of the state-transition graph at a user interface (act 840).

Subsequently the system is configured to receive a user input through the user interface for modifying the state-transition graph (act 850). The user input defining a modification to the state-transition graph. In response to receiving the user input, modifying the state-transition graph based on the user input (act 860).

Wherein the state-transition graph further includes an intermediary state between the first plan state and the second plan state, modifying the state-transition graph includes traversing the intermediary state.

In some instances, modifying the state-transition graph includes modifying one or more constraint parameters by which the state-transition graph is generated from the dependency graph. In some instances, modifying the state-transition graph includes setting a trigger based on a pre-determined condition being met. It should be appreciated that the modifications made to the state-transition graph can be made using any of the systems and methods described herein (e.g., graphical, numerical and/or code-based modifications.)

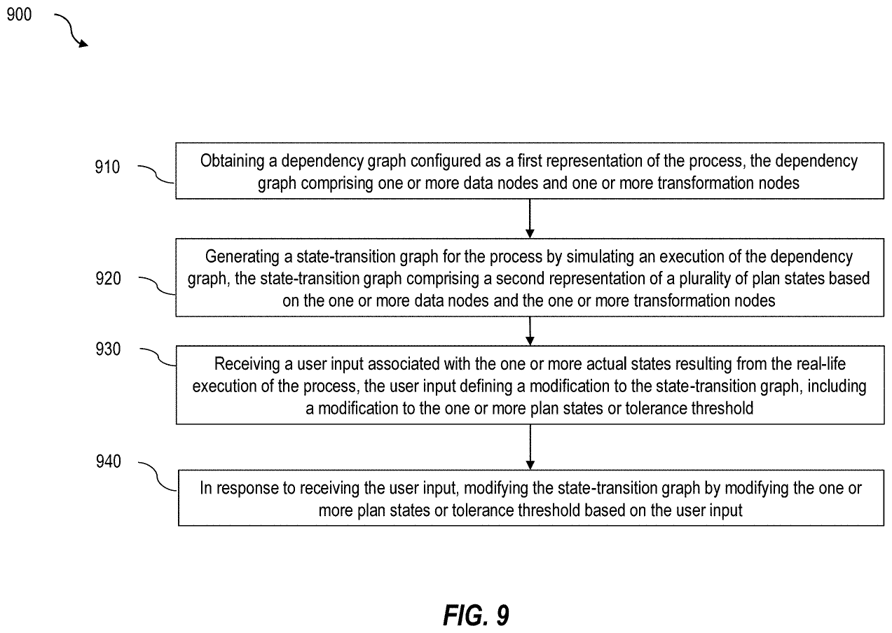

Attention will now be directed to FIG. 9, in some reference to FIG. 1, which illustrates a flow diagram 900 that includes various acts (act 910, act 920, act 930, and act 940) associated with exemplary methods that can be implemented by computing system 110 for modifying a state-transition graph based on a real life execution of the process represented by the state-transition graph. As illustrated the system obtains a dependency graph configured as a first representation of the process (act 910). The dependency graph comprising one or more data nodes and one or more transformation nodes.

The system generates a state-transition graph for the process by simulating an execution of the dependency graph (act 920). The state-transition graph comprises a second representation of a plurality of plan states based on the one or more data nodes and the one or more transformation nodes including: a first plan state corresponding to a start state associated with the process, a second plan state corresponding to a goal state associated with the process, the goal state being dependent on the start state, a transition representing a path for the process to progress from the start state to the goal state, and a tolerance threshold defining a pre-specified deviation range for one or more actual states occurring during a real-life execution of the process deviating from one or more plan states included in the state-transition graph, each actual state corresponding to at least one plan state included in the state-transition graph.

The system receives a user input associated with the one or more actual states resulting from the real-life execution of the process (act 930). The user input defines a modification to the state-transition graph, including a modification to the one or more plan states or tolerance threshold. In response to receiving the user input, the system modifies the state-transition graph by modifying the one or more plan states or tolerance threshold based on the user input (act 940). It should be appreciated that the modifications made to the state-transition graph can be made using any of the systems and methods described herein (e.g., graphical, numerical and/or code-based modifications.)

In some instances, when determining that the tolerance threshold for defining a particular pre-specified deviation range of a particular actual state is exceeded, the system prompts a user to provide user input to modify the state-transition graph.

Additionally, or alternatively, when determining that one or more input sources of the process represented by the dependency graph are accessible by the computing system, the system generates a notification to a user that the process is online.

In view of the foregoing, it will be appreciated that the disclosed embodiments provide many technical benefits over conventional systems and methods for building, training, and utilizing machine learning models for human-in-the-loop interactive planning in high dimensional space.

Embodiments of the present invention may comprise or utilize a special purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media (e.g., hardware storage device(s) 140 of FIG. 1) that store computer-executable instructions (e.g., computer-readable instructions 118 of FIG. 1) are physical hardware storage media/devices that exclude transmission media. Computer-readable media that carry computer-executable instructions or computer-readable instructions (e.g., computer-readable instructions 118) in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system configured to dynamically generate and modify a state-transition graph corresponding to different states of a process represented by the state-transition graph, the computing system comprising:
one or more processors; and
one or more hardware storage devices storing one or more computer-readable instructions that are executable by the one or more processors to configure the computing system to at least:
obtain a dependency graph configured as a first representation of the process, the dependency graph comprising one or more data nodes and one or more transformation nodes;
receive a user input defining one or more parameter constraints of the dependency graph; and
generate a state-transition graph for the process by simulating an execution of the dependency graph based on the one or more parameter constraints, the state-transition graph comprising a second representation of a plurality of plan states based on the one or more data nodes and the one or more transformation nodes including:
a first plan state corresponding to a start state associated with the process,
a second plan state corresponding to a goal state associated with the process, the goal state being dependent on the start state,
a transition representing a path for the process to progress from the start state to the goal state, and
a tolerance threshold defining a pre-specified deviation range of one or more of the plurality of plan states.

2. The computing system of claim 1, wherein at least one transformation node is configured as a data function that performs a transformation on input data.

3. The computing system of claim 1, wherein at least one transformation node is configured as a constraint solver that at least partially solves a constraint to generate a solution as an output.

4. The computing system of claim 1, wherein at least one transformation node is configured as a probabilistic model.

5. The computing system of claim 1, wherein at least one transformation node is configured as an artificial intelligence model.

6. The computing system of claim 5, wherein the artificial intelligence model is trained to perform a classification task.

7. The computing system of claim 5, wherein the artificial intelligence model is trained to perform a regression task.

8. The computing system of claim 1, wherein the dependency graph includes at least one back edge configured as an implicit back edge or an explicit back edge.

9. The computing system of claim 1, wherein the dependency graph is segmented into a plurality of subgraphs and the one or more computer-readable instructions are further executable to further configure the computing system to:
execute a particular subgraph for a fixed number of iterations or until a pre-determined condition is met.

10. The computing system of claim 1, wherein the transition is a result of an action.

11. The computing system of claim 1, wherein the transition is a result of an intervention triggered by the computing system.

12. The computing system of claim 1, wherein the transition is a result of a condition being met or a condition being violated.

13. The computing system of claim 1, wherein the state-transition graph further includes an implicit intermediate state.

14. A computing system configured for dynamically generating and modifying a state-transition graph corresponding to different states of a process represented by the state-transition graph, the computing system comprising:
one or more processors; and
one or more hardware storage devices storing one or more computer-readable instructions that are executable by the one or more processors to configure the computing system to at least:
obtain a dependency graph configured as a first representation of the process, the dependency graph comprising one or more data nodes and one or more transformation nodes;
generate a state-transition graph for the process by simulating an execution of the dependency graph, the state-transition graph comprising a second representation of a plurality of plan states based on the one or more data nodes and the one or more transformation nodes including:
a first plan state corresponding to a start state associated with the process,
a second plan state corresponding to a goal state associated with the process, the goal state being dependent on the start state,
a transition representing a path for the process to progress from the start state to the goal state, and
a tolerance threshold defining a pre-specified deviation range of one or more of the plurality of plan states;
simulate an execution of the state-transition graph;
generate and present one or more outputs from simulating the execution of the state-transition graph at a user interface;
receive a user input through the user interface for modifying the state-transition graph, the user input defining a modification to the state-transition graph; and
in response to receiving the user input, modify the state-transition graph based on the user input.

15. The computing system of claim 14,
wherein the state-transition graph further includes an intermediary state between the first plan state and the second plan state; and
wherein the modification to the state-transition graph includes traversing the intermediary state.

16. The computing system of claim 14, wherein the modification to the state-transition graph includes modifying one or more constraint parameters by which the state-transition graph is generated from the dependency graph.

17. The computing system of claim 14, wherein the modification to the state-transition graph includes setting a trigger based on a pre-determined condition being met.

18. A computing system configured to dynamically generate and modify a state-transition graph corresponding to different states of a process represented by the state-transition graph, the computing system comprising:
one or more processors; and
one or more hardware storage devices storing one or more computer-readable instructions that are executable by the one or more processors to configure the computing system to at least:
obtain a dependency graph configured as a first representation of the process, the dependency graph comprising one or more data nodes and one or more transformation nodes;
generate a state-transition graph for the process by simulating an execution of the dependency graph, the state-transition graph comprising a second representation of a plurality of plan states based on the one or more data nodes and the one or more transformation nodes including:
a first plan state corresponding to a start state associated with the process,
a second plan state corresponding to a goal state associated with the process, the goal state being dependent on the start state,
a transition representing a path for the process to progress from the start state to the goal state, and
a tolerance threshold defining a pre-specified deviation range for one or more actual states occurring during a real-life execution of the process deviating from one or more plan states included in the state-transition graph, each actual state corresponding to at least one plan state included in the state-transition graph;
receive a user input associated with the one or more actual states resulting from the real-life execution of the process, the user input defining a modification to the state-transition graph, including a modification to the one or more plan states or tolerance threshold; and
in response to receiving the user input, modify the state-transition graph by modifying the one or more plan states or tolerance threshold based on the user input.

19. The computing system of claim 18, the one or more computer-readable instructions being further executable to further configure the computing system to:
determine that the tolerance threshold for defining a particular pre-specified deviation range of a particular actual state is exceeded; and
prompt a user to provide user input to modify the state-transition graph.

20. The computing system of claim 18, the one or more computer-readable instructions being further executable to further configure the computing system to:
determine that one or more input sources of the process represented by the dependency graph are accessible by the computing system; and
generate a notification to a user that the process is online.
